(19) United States
(12) Patent Application Publication
(10) Pub. No.: US 2026/0327147 A1
(43) Pub. Date: Oct. 22, 2026

(54) DIELECTRIC SLURRY USING DISPERSANT AND METHOD OF PREPARING DISPERSANT

(71) Applicant: SAMSUNG ELECTRO-MECHANICS CO., LTD., Suwon-si (KR)

(72) Inventors: Tae Min Kim, Suwon-si (KR); Hyun Gyoo Roh, Suwon-si (KR); Geum Hee Yun, Suwon-si (KR); Kyung Min Ok, Suwon-si (KR); Myung Hyun Jo, Suwon-si (KR); Ye Ri Yu, Suwon-si (KR)

(73) Assignee: SAMSUNG ELECTRO-MECHANICS CO., LTD., Suwon-si (KR)

(21) Appl. No.: 19/697,003

(22) Filed: Jun. 3, 2026

Related U.S. Application Data
(62) Division of application No. 18/198,542, filed on May 17, 2023.

(30) Foreign Application Priority Data
Jan. 3, 2023 (KR) 10-2023-0000715

(51) Int. Cl. C04B 35/634; C04B 35/468; C04B 35/626; C08F 116/38; H01G 4/12; H01G 4/30

(52) U.S. Cl. CPC C04B 35/6342; C04B 35/4682; C04B 35/6264; C08F 116/38; H01G 4/1227; C04B 2235/3236; H01G 4/30

(57) ABSTRACT

A dispersant includes a polyvinyl acetal-based resin having a degree of polymerization in a range from 100 to 200, an amount of hydroxyl groups in a range from 4 mol% to 40 mol%, an amount of acetal groups in a range from 40 mol% to 95 mol%, and an amount of acetyl groups in a range from 1 mol% to 20 mol%.

### CROSS-REFERENCE TO RELATED APPLICATIONS

This application is a divisional application of U.S. Patent Application No. 18/198,542, filed on May 17, 2023, which claims benefit of priority to Korean Patent Application No. 10-2023-0000715 filed on Jan. 3, 2023, the disclosures of which are incorporated herein by reference in their entireties.

### TECHNICAL FIELD

The present disclosure relates to a dispersant, a dielectric slurry using the same, and a method of preparing the same.

### BACKGROUND

A multilayer ceramic capacitor (MLCC), a multilayer electronic component, is a chip-type condenser mounted on the printed circuit boards of various types of electronic products such as imaging devices, including a liquid crystal display (LCD) and a plasma display panel (PDP), computers, smartphones, and mobile phones, and serves to charge or discharge electricity therein or therefrom.

The multilayer ceramic capacitor may be used as a component of various electronic devices due to having a small size, ensuring high capacitance and being easily mounted. With the miniaturization and high output power in various electronic devices such as computers and mobile devices, demand for miniaturization and implementation of high capacitance of multilayer ceramic capacitors has also been increasing.

In the case of a fine dielectric particle for manufacturing small-sized and high-capacitance multilayer electronic components, an agglomeration phenomenon may easily occur due to electrostatic properties of a surface thereof. Such an agglomeration phenomenon may make it difficult to smoothly implement dielectric properties and generate non-uniformities in the dielectric properties of a product. Thus, in order to solve such an issue, a dispersant may be added to disperse the dielectric particle in a process of manufacturing the components. However, unlike a binder, the dispersant is considered to be less important, and thus research into various factors affecting the dispersibility of the dispersant is relatively lacking.

### Related Art Document

### Patent Document

Patent Document 1: Korean Patent Application Publication No. 10-2011-7024874

Patent Document 2: Korean Patent Application Publication No. 10-2019-0121222

### SUMMARY

An aspect of the present disclosure provides a polymer dispersant having an ultra-low degree of polymerization and a dielectric slurry using the same.

However, the aspects of the present disclosure are not limited to those set forth herein, and will be more easily understood in the process of describing specific example embodiments of the present disclosure.

According to an aspect of the present disclosure, there is provided a dispersant including a polyvinyl acetal-based resin having a degree of polymerization in a range from 100 to 200, an amount of hydroxyl groups in a range from 4 mol% to 40 mol%, an amount of acetal groups in a range from 40 mol% to 95 mol%, and an amount of acetyl groups in a range from 1 mol% to 20 mol%.

According to another aspect of the present disclosure, there is provided a dielectric slurry including dielectric particle, and a dispersant including a first polyvinyl acetal-based resin having a degree of polymerization in a range from 100 to 200, an amount of hydroxyl groups in a range from 4 mol% to 40 mol%, an amount of acetal groups in a range from 40 mol% to 95 mol%, and an amount of acetyl groups in a range from 1 mol% to 20 mol%.

According to another aspect of the present disclosure, there is provided a method of preparing a dispersant, the method including preparing a first solution by dissolving polyvinyl alcohol in an organic solvent, preparing a second solution by adding an acidic solution to the first solution, preparing a third solution by adding an aldehyde to the second solution, and obtaining a polyvinyl acetal-based resin by precipitating the third solution in a water-soluble solvent. The polyvinyl acetal-based resin may have a degree of polymerization in a range from 100 to 200, an amount of hydroxyl groups in a range from 4 mol% to 40 mol%, an amount of an acetal groups in a range from 40 mol% to 95 mol%, and an amount of acetyl groups in a range from 1 mol% to 20 mol%.

According to example embodiments of the present disclosure, a polymer dispersant having an ultra-low degree of polymerization may be used, thereby improving the dispersibility of a dielectric slurry.

However, the various and beneficial advantages and effects of the present disclosure are not restricted to those set forth herein, and will be more easily understood in the process of describing specific example embodiments.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a schematic process view of a method of preparing a dispersant according to an example embodiment of the present disclosure;

FIG. 2 schematically illustrates a reaction process of a polyvinyl acetal-based resin;

FIG. 3 is a schematic perspective view illustrating a multilayer electronic component according to an example embodiment of the present disclosure;

FIG. 4 is a schematic exploded perspective view illustrating a structure in which internal electrodes are stacked;

FIG. 5 is a schematic cross-sectional view taken along line I-I' of FIG. 3; and

FIG. 6 is a schematic cross-sectional view taken along line II-II' of FIG. 3.

### DETAILED DESCRIPTION

Hereinafter, example embodiments of the present disclosure are described with reference to the accompanying drawings. The present disclosure may, however, be exemplified in many different forms and should not be construed as being limited to the specific example embodiments set forth herein. In addition, example embodiments of the present disclosure may be provided for a more complete description of the present disclosure to those skilled in the art. Accordingly, the shapes and sizes of the elements in the drawings may be exaggerated for clarity of description, and the elements denoted by the same reference numerals in the drawings may be the same elements.

In order to clearly illustrate the present disclosure, portions not related to the description are omitted, and sizes and thicknesses are magnified in order to clearly represent layers and regions, and similar portions having the same functions within the same scope are denoted by similar reference numerals throughout the specification. Throughout the specification, when an element is referred to as "comprising" or "including," it means that it may include other elements as well, rather than excluding other elements, unless specifically stated otherwise.

In the drawings, a first direction may be defined as a length (L) direction, a second direction may be defined as a thickness (T) direction, and a third direction may be defined as a width (W) direction.

### Dispersant

In the case of a fine dielectric particle for manufacturing small-sized and high-capacitance multilayer electronic components, an agglomeration phenomenon may easily occur due to electrostatic properties of a surface thereof. Such an agglomeration phenomenon may make it difficult to smoothly implement dielectric properties and generate non-uniformities such as dielectric properties of a product. Thus, in order to solve such an issue, a dispersant may be added for the dispersibility of dielectric particle.

However, unlike a binder, a dispersant for dielectric particle is considered to be less important, and thus, research into various factors affecting the dispersibility of the dispersant is relatively lacking.

An issue associated with agglomeration of dielectric particle may be resolved by preparing a dispersant using a homogeneous reaction method among polyvinyl acetal synthesis methods. The homogeneous reaction method may be a non-aqueous reaction method. Unlike a precipitation method, which is a water-based reaction, the homogeneous reaction method based on homogeneous reaction may facilitate control of a functional group as compared to the water-based reaction, and may allow acetalization at a high reaction rate to be implemented, such that the homogeneous reaction method may be suitable for research into dispersibility.

A polyvinyl acetal-based resin having a low degree of polymerization (DP) having a particle size may be prepared through homogeneous reaction. As compared to a case in which the precipitation method is used and a polyvinyl acetal-based resin having a high degree of polymerization, in the polyvinyl acetal-based resin having a high degree of polymerization, the agglomeration phenomenon may more easily occur due to a difference in method and a difference in polarity during collection of particles. Issues such as difficulty in handling and non-uniformity of a product may exist during operation. Here, a degree of polymerization (DP) refers to an average number of monomers bonded to form one chain of a polymer. In other words, the degree of polymerization is the ratio of the average molecular weight of the polymer to the molecular weight of the monomer forming the polymer.

A dispersant according to an embodiment of the present disclosure may include a polyvinyl acetal-based resin having a degree of polymerization in a range from 100 to 200, an amount of hydroxyl groups in a range from 4 mol% to 40 mol%, an amount of acetal groups in a range from 40 mol% to 95 mol%, and an amount of acetyl groups in a range from 1 mol% to 20 mol%. It will be understood that the term “in a range from X to Y” includes the values of X, Y and the values therebetween.

Here, the amount of hydroxyl groups, the amount of acetal groups, and the amount of acetyl groups may correspond to functional groups of the polyvinyl acetal-based resin, and a total thereof may satisfy 100 mol%.

In the case of a dispersant having a low degree of polymerization in a range from 100 to 200, a more uniform ceramic green sheet and a dielectric layer having a microstructure may be manufactured through uniform particle dispersion based on a particle size of a dielectric, thereby improving the reliability of a multilayer electronic component. In addition, the viscosity of a dielectric slurry may be adjusted using the dispersant having a low degree of polymerization, thereby optimizing a ceramic green sheet manufacturing process and shortening volatilization operation time.

When the degree of polymerization is less than 100, dispersibility may be uniformly secured. However, when a dielectric green sheet is formed of the dielectric slurry, a plasticization effect may be given, which may make it difficult to control extension. When the degree of polymerization is greater than 200, dispersibility may be reduced depending on a size of an dielectric particle to cause an agglomeration phenomenon, and compatibility with the binder may also be reduced to degrade surface roughness of the ceramic green sheet.

The amount of hydroxyl groups of the polyvinyl acetal-based resin may be in a range from 4 mol% to 40 mol%.

When the amount of hydroxyl groups is in a range from 4 mol% to 40 mol%, the dispersibility of dielectric particle in a dielectric slurry composition may be excellent, and the ceramic green sheet may have improved fluidity and rigidity.

When the amount of hydroxyl groups is less than 4 mol%, it may be difficult to sufficiently disperse dielectric particles, and thus agglomeration of the dielectric particles may occur, and dielectric sheet strength may be insufficient. When the amount of hydroxyl groups is greater than 40 mol%, solubility in organic solvents may be impaired, making it difficult to apply to various solvents. In this regard, aggregation of dielectric particle may occur.

The amount of acetal groups of the polyvinyl acetal-based resin may be in a range from 40 mol% to 95 mol%.

Here, the amount of acetal groups may refer to a ratio of the number of hydroxyl groups acetalized by butyraldehyde to the number of functional groups of the polyvinyl acetal-based resin. In a method of calculating the amount of acetal groups, acetal groups of the polyvinyl acetal-based resin may be acetalized from two hydroxyl groups, and thus mol% of the amount of acetal groups may be calculated using a method of counting the acetalized two hydroxyl groups.

When the amount of acetal groups of the polyvinyl acetal-based resin is in a range from 40 mol % to 95 mol %, solubility in organic solvents may be excellent.

When the amount of acetal groups of the polyvinyl acetal-based resin is less than 40 mol%, solubility in organic solvents may be impaired. When a degree of acetalization is greater than 95 mol%, industrial production of the polyvinyl acetal-based resin may be difficult.

The amount of acetyl groups of the polyvinyl acetal-based resin may be in a range from 1 mol% to 20 mol%.

When the amount of acetyl groups of the polyvinyl acetal resin is in a range from 1 mol% to 20 mol%, the amount of hydroxyl groups and the amount of acetal groups may be optimally adjusted, and the polyvinyl acetal-based resin may be easily adsorbed onto a surface of the dielectric particle, such that the dispersibility of the dielectric particle in the dielectric slurry may be excellent.

When the amount of acetyl groups of the polyvinyl acetal-based resin is less than 1 mol%, industrial production may be difficult. When the amount of acetyl groups is greater than 20 mol%, the viscosity of the dielectric slurry may be degraded, thereby lowering the dispersibility thereof.

In the dispersant according to an example embodiment of the present disclosure, the polyvinyl acetal-based resin may have a molecular weight in a range from 5000 g/mol to 16000 g/mol.

Here, the molecular weight may refer to a number average molecular weight, and may be determined by various conditions such as the above-described degree of polymerization, amount of hydroxyl groups, amount of acetal groups, and amount of acetyl groups, and in particular, may be mainly determined by the degree of polymerization.

When the molecular weight is less than 5000 g/mol, dispersibility may be uniformly secured. However, when a dielectric green sheet is formed of the dielectric slurry, a plasticization effect may be given, which may make it difficult to control extension. When the molecular weight is greater than 16000 g/mol, dispersibility may be reduced depending on a size of an dielectric particle to cause an agglomeration phenomenon, and compatibility with the binder may also be reduced to degrade surface roughness of the ceramic green sheet.

In an example embodiment of the present disclosure, the polyvinyl acetal-based resin may include polyvinyl butyral (PVB).

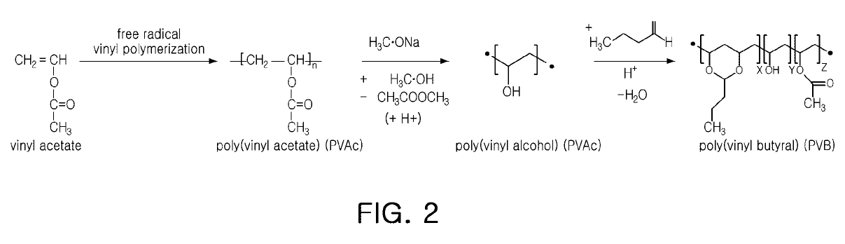

Referring to FIG. 2, which schematically illustrates a condensation reaction of polyvinyl acetal, the polyvinyl butyral (PVB) may be prepared by reacting polyvinyl alcohol (PVA) and butylaldehyde (BA) under a hydrochloric acid catalyst.

A polyvinyl butyral resin has a property of being easily dissolved in other organic solvents such as alcohol, ketone, and ester, and has good compatibility with other resins, for example, synthetic resins such as a phenol resin, a melamine resin, a urea resin, and an alkyd resin.

The polyvinyl butyral may serve as a dispersant for efficient dispersion of dielectric particle, and may also serve as a binder for imparting strength and adhesion to the ceramic green sheet.

Here, the dielectric particle may include metal particles, conductive particles, ceramic particles, dielectric particles, and glass particle.

Although the dispersant according to an embodiment of the present disclosure has been mainly described to be inserted into the dielectric slurry so as to improve the dispersibility of dielectric particles, the present disclosure is not particularly limited thereto, and the dispersant also be used as a dispersant of an internal electrode paste. When used as the dispersant of the internal electrode paste, the agglomeration of metal particles may be prevented and the dispersibility of the metal particles may be improved. That is, the dielectric particle may have improved dispersibility.

### Dielectric Slurry

A dielectric slurry according to another embodiment of the present disclosure may include dielectric particle, and a dispersant including a first polyvinyl acetal-based resin having a degree of polymerization in a range from 100 to 200, an amount of hydroxyl groups in a range from 4 mol% to 40 mol%, an amount of acetal groups in a range from 40 mol% to 95 mol%, and an amount of acetyl groups in a range from 1 mol% to 20 mol%.

That is, dielectric particle may have improved dispersibility by inserting a dispersant including a polyvinyl acetal-based resin into the dielectric slurry.

In the description of the dielectric slurry, a polyvinyl acetal-based resin treated as a dispersant may be defined as a first polyvinyl acetal-based resin, and a polyvinyl acetal-based resin treated as a binder may be defined as a second polyvinyl acetal-based resin.

A content of the dispersant may be in a range from 0.1 parts by weight to 20 parts by weight relative to 100 parts by weight of the dielectric particle.

When the content of the dispersant is in a range from 0.1 parts by weight to 20 parts by weight relative to 100 parts by weight of the dielectric particle, the first polyvinyl acetal-based resin may be easily adsorbed onto the surface of the dielectric particle, thereby further improving the dispersibility of the dielectric particle in the dielectric slurry.

When the content of the dispersant is less than 0.1 part by weight relative to 100 parts by weight of the dielectric particle, the dielectric particle may have insufficient dispersibility. When the content of the dispersant is greater than 20 parts by weight relative to 100 parts by weight of the dielectric particle, the dielectric may have impaired dispersibility due to aggregation between the dispersants, and the viscosity may become excessively high, such that there may be difficulty in handling during operation with dielectric slurry.

The binder may include a polyvinyl acetal-based resin, a material same as that of the dispersant, but may be different in terms of a degree of polymerization, a molecular weight, types or contents of various functional groups, and the like, thereby performing a role different from that of the dispersant.

In general, the binder may serve to improve bonding between a ceramic green sheet formed by applying the dielectric slurry and an internal electrode pattern formed by applying the internal electrode paste.

When a degree of polymerization of the second polyvinyl acetal-based resin in a range from 200 to 5000, the ceramic green sheet may have improved strength and the viscosity of the dielectric slurry may be maintained on an appropriate level, for example, smooth coating may be performed on a carrier film, such that a ceramic green sheet having a uniform thickness may be manufactured.

When the degree of polymerization of the second polyvinyl acetal-based resin is less than 200, the ceramic green sheet may have insufficient sheet strength. When the degree of polymerization is greater than 5000, the viscosity of the dielectric slurry may become excessively high, such that smooth coating may not be performed.

The content of the binder may be in a range from 0.01 parts by weight to 40 parts by weight relative to 100 parts by weight of the dielectric particle.

When the content of the binder is in a range from 0.01 parts by weight to 40 parts by weight relative to 100 parts by weight of the dielectric particle, the dielectric particle may have improved dispersibility, and the ceramic green sheet may have excellent strength, flexibility, and adhesion.

When the content of the binder is less than 0.01 parts by weight relative to 100 parts by weight of the dielectric particle, dielectric particle may have insufficient dispersibility, and the ceramic green sheet may have degraded strength, flexibility, and adhesion. When the content of the binder exceeds 40 parts by weight relative to 100 parts by weight of the dielectric particle, the viscosity of the dielectric slurry may become excessively high or the dielectric slurry may have lowered coating property, such that there may be difficulty in handling during operation.

The dielectric slurry of the present disclosure may further include additives including a plasticizer, a lubricant, an antistatic agent, and the like as appropriate within a range that does not impair dispersibility.

The following methods may be used to detect and measure compositions included in the dielectric slurry, but the present disclosure is not particularly limited thereto.

Whether the polyvinyl acetal-based resin is synthesized may be detected using ¹H-Nuclear Magnetic Resonance (¹H-NMR) or Fourier transform infrared (FTIR).

More specifically, after the prepared polyvinyl acetal-based resin is dissolved in a dimethyl sulfoxide (DMSO-d6) solvent, a degree of acetalization and a ratio of each functional group may be verified through ¹H-NMR.

As another method, after the prepared polyvinyl acetal-based resin is prepared as a 10% solution, the 10% solution may be coated on a film to a thickness in a range from 10 μm to 20 μm through a casting method. Thereafter, a degree of acetalization and a ratio of each functional group may be verified through FTIR transmission analysis based on JIS-K-6728.

In addition, after dielectric particles and a first polyvinyl acetal-based resin solution having a DP in a range from 100 to 200, the dispersant, are mixed, a degree of dispersion of the dielectric particles and the preparation of the slurry may be verified through a particle size analysis method such as dynamic light scattering (DLS).

In addition, after the dielectric particles and a second polyvinyl acetal-based resin solution having a DP in a range from 200 to 5000 , the dispersant, are mixed, a degree of dispersion of the dielectric particles and the preparation of the slurry may be additionally verified through a particle size analysis method such as DLS.

### Method of Preparing Dispersant

Hereinafter, a method of preparing a dispersant will be described, and a description the same as that of the above-described dispersant will be omitted.

In general, a polyvinyl acetal-based resin may be obtained by a precipitation method, an aqueous reaction method using an acid catalyst in a solution including polyvinyl alcohol (PVA) as a raw material. However, when the precipitation method is used, it may be difficult to obtain a dispersant having an ultra-low degree of polymerization, the dispersant having a DP of 200 or less due to the properties of cross-linking side reactions and heterogeneous reactions.

Accordingly, in the present disclosure, a non-aqueous homogeneous reaction method, using a polar aprotic solvent capable of dissolving both polyvinyl alcohol and polyvinyl acetal, may be used, thereby obtaining a polyvinyl acetal-based resin having an ultra-low degree of polymerization, the polyvinyl acetal-based resin having a DP of 200 or less.

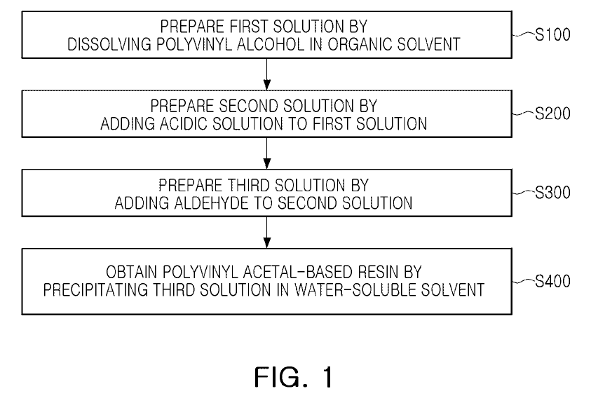

Referring to FIG. 1, according to an embodiment of the present disclosure, a method of preparing a dispersant may include preparing a first solution by dissolving polyvinyl alcohol in an organic solvent (S100), preparing a second solution by adding an acidic solution to the first solution (S200), preparing a third solution by adding aldehyde to the second solution (S300), and obtaining a polyvinyl acetal-based resin by precipitating the third solution in a water-soluble solvent (S400). The polyvinyl acetal-based resin may have a degree of polymerization in a range from 100 to 200, an amount of hydroxyl groups in a range from 4 mol% to 40 mol%, an amount of acetal groups in a range from 40 mol% to 95 mol%, and an amount of acetyl groups in a range from 1 mol% to 20 mol%.

The polyvinyl acetal may be obtained by a condensation (acetalization) reaction between polyvinyl alcohol and aldehyde.

As another method of preparing the polyvinyl acetal, the polyvinyl acetal may be synthesized by simultaneously performing a saponification reaction of the polyvinyl acetate and a condensation reaction of the aldehyde.

The polyvinyl acetal may have a variety of properties depending on a type and ratio of bonded aldehyde, a degree of acetalization, an amount of residual acetyl groups, a degree of polymerization of polyvinyl alcohol as a raw material, and the like. That is, the polyvinyl acetal may have various properties depending on a degree of polymerization or a molecular weight.

First, the operation (S100) of preparing the first solution by dissolving polyvinyl alcohol in the organic solvent may be performed.

Referring to FIG. 2, polyvinyl alcohol may be obtained by obtaining polyvinyl acetate (PVAc) through free radical polymerization of vinyl acetate, and then adding methyl alcohol and sodium hydroxide (NaOH) to perform hydrolysis thereon under a temperature condition of 30 °C to 50 °C.

The polyvinyl alcohol may have a degree of polymerization in a range from 100 to 200 and a molecular weight in a range from 4000 g/mol to 11000 g/mol.

According to the preparation method of the present disclosure, the degree of polymerization and the molecular weight of the polyvinyl alcohol, a raw material, before the condensation reaction of the polyvinyl acetal-based resin, may not significantly affect the degree of polymerization and the molecular weight of the obtained polyvinyl acetal, and the polyvinyl alcohol and the polyvinyl acetal may be obtained to have the same or similar properties.

The polyvinyl alcohol may be obtained by copolymerizing an ethylenically unsaturated monomer within a range that does not impair the effects of the present disclosure. The ethylenically unsaturated monomer is not particularly limited, and for example, may be acrylic acid, methacrylic acid, (anhydrous) phthalic acid, (anhydrous) maleic acid, (anhydrous) itaconic acid, acrylonitrile methacrylonitrile, acrylamide, methacryl amide, trimethyl-(3-acrylamide-3-dimethylpropyl)-ammonium chloride, acrylamide-2-methylpropane sulfonic acid and a sodium salt thereof; ethyl vinyl ether, butyl vinyl ether, N-vinyl pyrrolidone, vinyl chloride, vinyl bromide, vinyl fluoride, vinylidene chloride, vinylidene fluoride, tetrafluoroethylene, sodium vinyl sulfonate, sodium aryl sulfonate, and the like. In addition, terminal modified polyvinyl alcohol obtained by copolymerizing a vinyl ester monomer such as vinyl acetate and ethylene and saponifying the same in the presence of thiol compounds such as thiol acetic acid and mercaptopropionic acid may be used.

The polyvinyl alcohol may be obtained by saponifying a copolymer obtained by copolymerizing the vinyl ester and α-olefin. The polyvinyl alcohol may further copolymerize the ethylenically unsaturated monomer and contain a component derived from the ethylenically unsaturated monomer. In addition, terminal polyvinyl alcohol obtained by copolymerizing a vinyl ester monomer such as vinyl acetate and the α-olefin and saponifying the same in the presence of thiol compounds such as thiol acetic acid and mercaptopropionic acid. The α-olefin is not particularly limited, and may include, for example, methylene, ethylene, propylene, isopropylene, butylene, isobutylene, pentylene, hexylene, cyclohexylene, cyclohexyl ethylene, cyclohexyl propylene, and the like.

As the organic solvent, any polar aprotic solvent may be used, and preferably, any material capable of dissolving both the polyvinyl alcohol and the polyvinyl acetal-based resin may be used. Here, the polar aprotic solvent may refer to a solvent that has polarity but does not have a O-H bond or an N-H bond group, and thereby cannot serve as a proton donor for hydrogen bonding.

As the polar aprotic solvent, for example, N-methyl-2-pyrrolidone (NMP) may be preferably used, but is not particularly limited thereto, and the polar aprotic solvent may include at least one selected from acetone, ethyl acetate, acetonitrile, tetrahydrofuran, dimethyl sulfoxide, N-dimethylformamide, N,N-dimethylacetamide, pyridine, and hexamethylphosphoramide. The organic solvents may be used alone or in combination of two or more types thereof.

A degree of saponification of the polyvinyl alcohol may be 80% or more, preferably 98% or more, and more preferably 99% or more, based on mole percentage (mol%) in consideration of the amount of acetyl groups of the polyvinyl acetal. A molecular weight thereof may be 4000 g/mol or more and 11000 g/mol or less. When dissolving the polyvinyl alcohol in an organic solvent, the polyvinyl alcohol may preferably be dissolved at a temperature of 100 °C to 150 °C, and may more preferably be maintained at a temperature of 120 °C. Dissolution time may be preferably 30 minutes to 2 hours, and more preferably, the first solution may be stirred and dissolved for 1 hour.

Subsequently, the operation (S200) of preparing the second solution by adding an acidic solution to the first solution so as to induce a condensation reaction may be performed.

As a catalyst for the condensation reaction, an inorganic substance such as hydrochloric acid or sulfuric acid may be used, and acetalization of polyvinyl alcohol may be provided by adding an acidic solution.

In this case, a concentration of hydrochloric acid may be preferably 30% or more and 40% or less, and more preferably 35%. For hydrochloric acid, since there is a risk that heat may occur, the hydrochloric acid may be dissolved while maintaining a relatively low temperature of 40 °C or less, more preferably 30 °C.

Subsequently, the operation (S300) of preparing the third solution by adding aldehyde to the second solution may be performed.

The aldehyde may be a compound in which a formyl group is added to a hydrocarbon group, and a molecular formula thereof may be represented by R-CHO. As the aldehyde, formaldehyde and butyl aldehyde may be used, which may become polyvinyl formal (PVF) and polyvinyl butyral (PVB) by condensation reactions, respectively. That is, the polyvinyl formal and the polyvinyl butyral may correspond to polyvinyl acetals.

For example, the aldehyde may include, but is not limited to, acetaldehyde, propionaldehyde, benzaldehyde, and the like. For example, ketones may include, but is not limited to, acetone, methyl ethyl ketone, hexanone, cyclohexanone, and the like.

When the aldehyde is added and stirred, the aldehyde may be added relatively slowly. When an excessive amount of the aldehyde is added, work safety may be problematic. In addition, a constant temperature may be preferably maintained, and the polymer may remain soluble throughout the process.

Subsequently, the operation (S400) of obtaining the polyvinyl acetal-based resin by precipitating the third solution in the water-soluble solvent may be performed.

Here, sodium hydroxide may be added to a substance generated after 2 to 72 hours of the third solution, thereby obtaining the polyvinyl acetal-based resin.

The water-soluble solvent may be water, but the present disclosure is not particularly limited thereto, and any material having a water-soluble group may be used.

Here, when the sodium hydroxide is added, a polyvinyl acetal resin may be more easily obtained. The sodium hydroxide may be added in an amount in a range from 0.1 g to 5.0 g for 1 L of the water-soluble solvent.

Subsequently, the obtained polyvinyl acetal-based resin may be washed with water and dried in vacuum, thereby obtaining a polyvinyl acetal-based resin having a degree of polymerization in a range from 100 to 200, an amount of hydroxyl groups in a range from 4 mol% to 40 mol%, an amount of acetal groups in a range from 40 mol% to 95 mol%, and an amount of acetyl groups in a range from 1 mol% to 20 mol%.

The obtained polyvinyl acetal-based resin may be a polyvinyl butyral resin, but the present disclosure is not particularly limited thereto.

Hereinafter, the present disclosure will be described in more detail through examples. However, the examples are provided to aid understanding of the present disclosure, and the present disclosure is not limited by the examples.

### Examples

In Example 1, 11.5 g of PVA (a degree of saponification of 80%) having a DP of 190, a molecular weight of 10000 g/mol, and an amount of acetyl groups of 20.0 mol% was dissolved in 500 mL of N-methylpyrrolidone (NMP) at 120 °C for 1 hour. Then, condensation was catalyzed by the addition of 0.65 mL of hydrochloric acid (35%). 5.83 mL of butyraldehyde (BA) was added slowly while stirring at a predetermined temperature of 30 °C. A mixture thereof was stirred while maintaining the predetermined temperature (30 °C), and a polymer remained soluble throughout the process. After two hours, a resultant product was slowly precipitated in 4.5 L of water containing 2.25 g of sodium hydroxide to obtain a polyvinyl butyral resin, which was washed several times and then finally dried in vacuum.

The polyvinyl butyral resin obtained in Example 1 was verified to have a functional group having a DP of 190, an amount of hydroxyl groups of 25.2 mol%, an amount of acetal groups of 54.8 mol%, and an amount of acetyl groups of 20.0 mol%.

In Example 2, 11.5 g of PVA (a degree of saponification of 99%) having a DP of 190, a molecular weight of 8500 g/mol, and an amount of acetyl groups of 3.0 mol% was dissolved in 500 mL of N-methylpyrrolidone (NMP) at 120 °C for 1 hour. Then, condensation was catalyzed by the addition of 0.65 mL of hydrochloric acid (35%). 5.83 mL of butyraldehyde (BA) was added slowly while stirring at a predetermined temperature of 30 °C. A mixture thereof was stirred while maintaining the predetermined temperature (30 °C), and a polymer remained soluble throughout the process. After 2 hours, a resultant product was slowly precipitated in 4.5 L of water containing 2.25 g of sodium hydroxide to obtain a polyvinyl butyral resin, which was washed several times and then finally dried in vacuum.

The polyvinyl butyral resin obtained in Example 2 was verified to have a functional group of a DP of 190, an amount of hydroxyl groups of 30.5 mol%, an amount of acetal groups of 66.5 mol%, and an amount of acetyl groups of 3.0 mol%.

In Example 3, 11.5 g of PVA (a degree of saponification of 99%) having a DP of 190, a molecular weight of 8500 g/mol, and an amount of acetyl groups of 3.0 mol% was dissolved in 500 mL of N-methylpyrrolidone (NMP) at 120 °C for 1 hour. Then, condensation was catalyzed by the addition of 1.95 mL of hydrochloric acid (35%). 17.49 mL of butyraldehyde (BA) was slowly added while stirring at a predetermined temperature of 30 °C. A mixture thereof was stirred while maintaining the predetermined temperature (30 °C), and a polymer remained soluble throughout the process. After 2 hours, a resultant product was slowly precipitated in 4.5 L of water containing 2.25 g of sodium hydroxide to obtain a polyvinyl butyral resin, which was washed several times and finally dried in vacuum.

The polyvinyl butyral resin obtained in Example 3 was verified to have a functional group of a DP of 190, an amount of hydroxyl groups of 25.3 mol%, an amount of acetal groups of 71.7 mol%, and an amount of acetyl groups of 3.0 mol%.

In Example 4, 11.5 g of PVA (a degree of saponification of 99%) having a DP of 190, a molecular weight of 8500 g/mol, and an amount of acetyl groups of 3.0 mol% was dissolved in 500 mL of N-methylpyrrolidone (NMP) at 120 °C for 1 hour. Then, condensation was catalyzed by the addition of 3.9 mL of hydrochloric acid (35%). 34.98 mL of butyraldehyde (BA) was added slowly while stirring at a predetermined temperature of 30 °C. A mixture thereof was stirred while maintaining the predetermined temperature (30 °C), and a polymer remained soluble throughout the process. After 2 hours, a resultant product was slowly precipitated in 4.5 L of water containing 2.25 g of sodium hydroxide to obtain a polyvinyl butyral resin, which was washed several times and then finally dried in vacuum.

The polyvinyl butyral resin obtained in Example 4 was verified to have a functional group having a DP of 190, an amount of hydroxyl groups of 4.7 mol%, an amount of acetal groups of 92.3 mol%, and an amount of acetyl groups of 3.0 mol%.

In Example 5, 11.5 g of PVA (a degree of saponification of 80%) having a DP of 120, a molecular weight of 6500 g/mol, and an amount of acetyl groups of 20.0 mol% was dissolved in 500 mL of N-methylpyrrolidone (NMP) at 120 °C for 1 hour. Then, condensation was then catalyzed by the addition of 0.65 mL of hydrochloric acid (35%). 5.83 mL of butyraldehyde (BA) was added slowly while stirring at a predetermined temperature of 30 °C. A mixture thereof was stirred while maintaining the predetermined temperature (30 °C), and a polymer thereof remained soluble throughout the process. After 2 hours, a resultant product was slowly precipitated in 4.5 L of water containing 2.25 g of sodium hydroxide to obtain a polyvinyl butyral resin, which was washed several times and then finally dried in vacuum.

The polyvinyl butyral resin obtained in Example 5 was verified to have a functional group having a DP of 120, an amount of hydroxyl groups of 25.2 mol%, an amount of acetal groups of 54.8 mol%, and an amount of acetyl groups of 20.0 mol%.

Hereinafter, a dielectric slurry into which the above-described dispersant is inserted will be described.

In Example 6, 100 parts by weight of barium titanate (BaTiO₃) powder, 700 parts by weight of an ethanol solvent, 1.0 parts by weight of a dispersant, which is a first polyvinyl acetal-based resin (polyvinyl butyral resin) obtained in Example 1 having a functional group having a DP of 190, an amount of hydroxyl groups of 25.2 mol%, an amount of acetal groups of 54.8 mol%, and an amount of acetyl groups of 20.0 mol%, and 20 parts by weight of a binder, which is a second polyvinyl acetal resin (polyvinyl butyral resin) having a DP of 1500 were added and stirred, and then stirred for two hours with a beads-mill to prepare a dielectric slurry suitable for manufacturing a ceramic green sheet.

The dielectric slurry prepared in Example 6 was verified to have an appropriate degree of dispersion of barium titanate (BaTiO₃) powder, viscosity of the dielectric slurry, and appropriate adhesive strength and strength when manufacturing a ceramic green sheet later.

### Multilayer Electronic Component

Hereinafter, a multilayer electronic component, including a dielectric layer formed by inserting the above-described dispersant into a dielectric slurry, or including an internal electrode formed by inserting the above-described dispersant into an internal electrode paste, will be described.

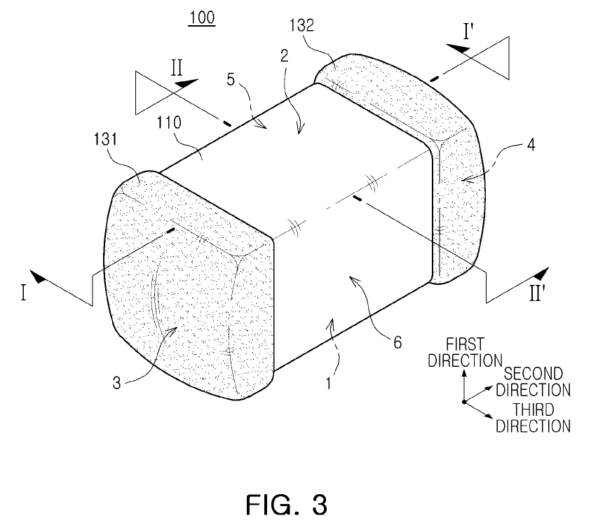

FIG. 3 is a schematic perspective view illustrating a multilayer electronic component according to an example embodiment of the present disclosure.

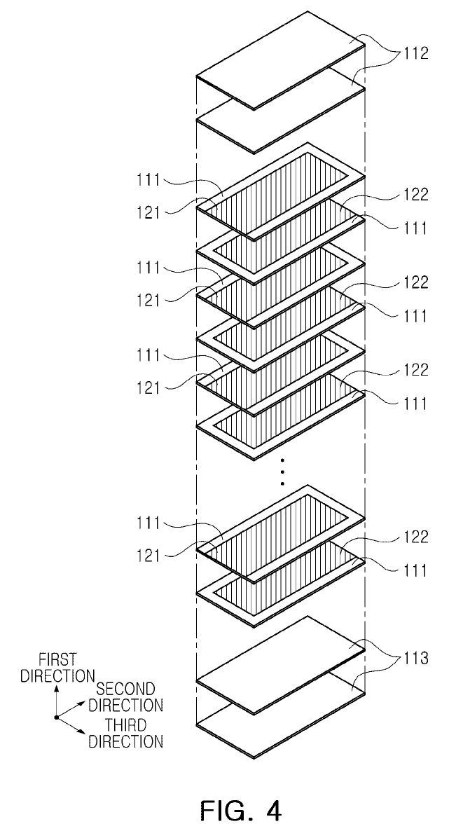

FIG. 4 is a schematic exploded perspective view illustrating a structure in which internal electrodes are stacked.

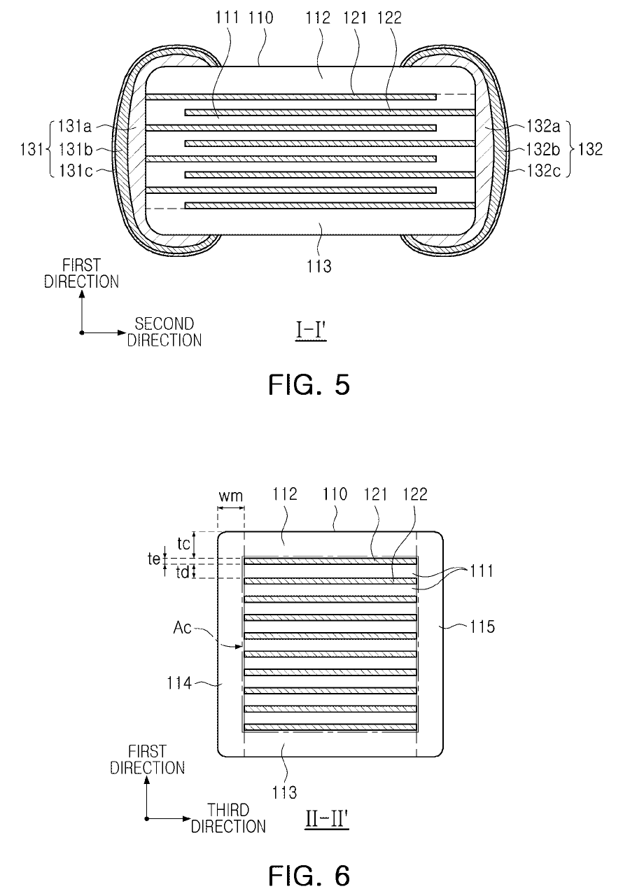

FIG. 5 is a schematic cross-sectional view taken along line I-I' of FIG. 3.

FIG. 6 is a schematic cross-sectional view taken along line II-II' of FIG. 3.

Hereinafter, a multiplayer electronic component according to an example embodiment of the present disclosure will be described in detail with reference to FIGS. 3-6. However, although a multilayer ceramic capacitor is described as an example of a multilayer electronic component, the present disclosure may be applied to various electronic products using a dielectric composition, such as inductors, piezoelectric elements, varistors, thermistors, or the like.

In the body 110, a dielectric layer 111 and internal electrodes 121 and 122 may be alternately stacked.

More specifically, the body 110 may include a capacitance formation portion Ac having capacitance formed by including the first internal electrode 121 and the second internal electrode 122 alternately disposed with the dielectric layer 111 interposed therebetween.

A specific shape of the body 110 is not particularly limited. However, as illustrated, the body 110 may have a hexahedral shape or a shape similar thereto. During a sintering process, ceramic particle included in the body 110 may be shrunken, such that the body 110 may not have a perfectly straight hexahedral shape, but may have a substantially hexahedral shape.

The body 110 may have first and second surfaces 1 and 2 opposing each other in a first direction, third and fourth surfaces 3 and 4 connected to the first and second surfaces 1 and 2 and opposing each other in a second direction, and fifth and sixth surfaces 5 and 6 connected to the first to fourth surfaces 1, 2, 3, and 4 and opposing each other in a third direction.

A plurality of dielectric layers 111 included in the body 110 may be in a sintered state, and adjacent dielectric layers 111 may be integrated with each other such that boundaries therebetween are not readily apparent without using a scanning electron microscope (SEM).

A raw material included in the dielectric layer 111 is not limited as long as sufficient capacitance is obtainable therewith. In general, a perovskite (ABO₃)-based material may be used. For example, a barium titanate-based material, a lead composite perovskite-based material, or a strontium titanate-based material may be used. The barium titanate-based material may include BaTiO₃-based ceramic particle. Examples of the ceramic particle may include (Ba₁₋ₓCaₓ)TiO₃ (0<x<1), Ba(Ti_{1-y}Ca_{y})O₃ (0<y<1), (Ba₁₋ₓCaₓ)(Ti_{1-y}Zr_{y})O₃ (0<x<1, 0<y<1), or Ba(Ti_{1-y}Zr_{y})O₃ (0<y<1) obtained by partially dissolving Ca or Zr in BaTiO₃.

In addition, as raw materials included in the dielectric layer 111, various ceramic additives, organic solvents, bonding agents, dispersants, and binders may be added to particles such as barium titanate (BaTiO₃), depending on the purpose of the present disclosure.

More specifically, a dispersant, including a first polyvinyl acetal-based resin having a degree of polymerization in a range from 100 to 200, an amount of hydroxyl groups in a range from 4 mol% to 40 mol%, an amount of acetal groups in a range from 40 mol% to 95 mol%, and an amount of acetyl groups in a range from 1 mol% to 20 mol%, may be added, or a binder, including a second polyvinyl acetal-based resin having a degree of polymerization in a range from 200 to 5000, may be added.

A thickness td of the dielectric layer 111 is not particularly limited.

However, in order to implement high capacitance of the multilayer electronic component, the thickness of the dielectric layer 111 may be 3.0 μm or less, and in order to more easily achieve miniaturization and to implement high capacitance of the multilayer electronic component, the thickness of the dielectric layer 111 may be 1.0 μm or less, preferably 0.6 μm or less, and more preferably 0.4 μm or less.

Here, the thickness td of the dielectric layer 111 may refer to a thickness td of the dielectric layer 111 interposed between the first and second internal electrodes 121 and 122.

The thickness td of the dielectric layer 111 may refer to a size of the dielectric layer 111 in the first direction. In addition, the thickness td of the dielectric layer 111 may refer to an average thickness td of the dielectric layer 111 and may refer to an average size of the dielectric layer 111 in the first direction.

The average size of the dielectric layer 111 in the first direction may be measured by scanning, with an SEM, cross-sections of the body 110 in the first and second directions at a magnification of 10,000. More specifically, the average size may be an average value of sizes of one dielectric layer 111 in the first direction, measured at thirty points equally spaced apart from each other in the second direction, in the scanned image. In addition, when such average value measurement is performed on ten dielectric layers 111, the average size of the dielectric layer 111 in the first direction may be further generalized.

The internal electrodes 121 and 122 may be alternately stacked with the dielectric layer 111.

The internal electrodes 121 and 122 may include a first internal electrode 121 and a second internal electrode 122, and the first and second internal electrodes 121 and 122 may be alternately disposed to oppose each other with the dielectric layer 111 included in the body 110 interposed therebetween, and may be exposed through the third and fourth surfaces 3 and 4 of the body 110, respectively.

More specifically, the first internal electrode 121 may be spaced apart from the fourth surface 4, and may be exposed through the third surface 3, and the second internal electrode 122 may be spaced apart from the third surface 3, and may be exposed through the fourth surface 4. The first external electrode 131 may be disposed on the third surface 3 of the body 110 to be connected to the first internal electrode 121, and the second external electrode 132 may be disposed on the fourth surface 4 of the body 110 to be connected to the second internal electrode 122.

That is, the first internal electrode 121 may not be connected to the second external electrode 132 and may be connected to the first external electrode 131, and the second internal electrode 122 may not be connected to the first external electrode 131 and may be connected to the second external electrode 132. In this case, the first and second internal electrodes 121 and 122 may be electrically isolated from each other by the dielectric layer 111 interposed therebetween.

The body 110 may be formed by alternately stacking a ceramic green sheet on which the first internal electrode 121 is printed and a ceramic green sheet on which the second internal electrode 122 is printed, and then performing sintering thereon.

A material included in the internal electrodes 121 and 122 is not particularly limited, and a material having excellent electrical conductivity may be used. For example, the internal electrodes 121 and 122 may include at least one of nickel (Ni), copper (Cu), palladium (Pd), silver (Ag), gold (Au), platinum (Pt), tin (Sn), tungsten (W), titanium (Ti), and alloys thereof.

In addition, the internal electrodes 121 and 122 may be formed by printing an internal electrode conductive paste including at least one of nickel (Ni), copper (Cu), palladium (Pd), silver (Ag), gold (Au), platinum (Pt), tin (Sn), tungsten (W), titanium (Ti), and alloys thereof, on a ceramic green sheet. A screen-printing method or a gravure-printing method may be used as a method for printing the internal electrode conductive paste, but the present disclosure is not limited thereto.

As raw materials included in an internal electrode conductive paste, various ceramic additives, organic solvents, bonding agents, dispersants, and binders may be added to a particle of a conductive material, a material having excellent electrical conductivity, depending on the purpose of the present disclosure.

More specifically, a dispersant, including a first polyvinyl acetal-based resin having a degree of polymerization in a range from 100 to 200, an amount of hydroxyl groups in a range from 4 mol% to 40 mol%, an amount of acetal groups in a range from 40 mol% to 95 mol%, and an amount of acetyl groups in a range from 1 mol% to 20 mol%, may be added, or a binder, including a second polyvinyl acetal-based resin having a degree of polymerization in a range from 200 to 5000, may be added.

A thickness te of the internal electrodes 121 and 122 is not particularly limited.

However, in order to implement high capacitance of the multilayer electronic components, the thickness of the internal electrodes 121 and 122 may be 1.0 μm or less, and in order to easily achieve miniaturization and to implement high capacitance of the multilayer electronic components, the thickness of the internal electrodes 121 and 122 may be 0.6 μm or less, and more desirably 0.4 μm or less.

Here, the thickness te of each of the internal electrodes 121 and 122 may refer to a size of each of the internal electrodes 121 and 122 in the first direction. In addition, the thickness te of each of the internal electrodes 121 and 122 may refer to an average thickness te of each of the internal electrodes 121 and 122, and may refer to an average size of each of the internal electrodes 121 and 122 in the first direction.

The average size of each of the internal electrodes 121 and 122 in the first direction may be measured by scanning, with an SEM, images of the cross-sections of the body 110 in the first and second directions at a magnification of 10,000. More specifically, the average size may be an average value of sizes of each of one internal electrode 121 or 122 in the first direction, measured at thirty points equally spaced apart from each other in the second direction, in the scanned image. The thirty points equally spaced apart from each other may be designated in the capacitance formation portion Ac. In addition, when an internal electrode on which such average value measurement is performed is extended to ten internal electrodes, the average size of each of the internal electrodes 121 and 122 in the first direction may be further generalized.

In an embodiment of the present disclosure, the thickness td of the dielectric layer 111 and the thickness te of the internal electrodes 121 and 122 may satisfy td > 2×te.

In other words, the thickness td of the dielectric layer 111 may be greater than twice the thickness te of the internal electrodes 121 and 122.

In general, high-voltage electrical components may have reliability issues due to a decrease in breakdown voltage (BDV) under a high-voltage environment.

Accordingly, in order to prevent the BDV from decreasing under the high-voltage environment, the thickness td of the dielectric layer 111 may be greater than twice the thickness te of each of the internal electrodes 121 and 122, thereby increasing the thickness of the dielectric layer, a distance between the internal electrodes, and improving properties of the BDV.

When the thickness td of the dielectric layer 111 is less than or equal to twice the thickness te of each of the internal electrodes 121 and 122, the dielectric layer, a distance between the internal electrodes, may be thin, such that the BDV may be decreased.

In the high-voltage electronic component, the thickness te of the internal electrode may be 1 μm or less, and the thickness td of the dielectric layer may be 3.0 μm or less, but the present disclosure is not limited thereto.

The body 110 may include cover portions 112 and 113 disposed on both end surfaces of the capacitance formation portion Ac in the first direction.

More specifically, the body 110 may include an upper cover portion 112 disposed on an upper portion of the capacitance formation portion Ac in the first direction, and a lower cover portion 113 disposed on a lower portion of the capacitance formation portion Ac in the first direction.

The upper cover portion 112 and the lower cover portion 113 may be formed by stacking a single dielectric layer 111 or two or more dielectric layers 111 in the first direction in upper and lower surfaces of the capacitance formation portion Ac, respectively, and may basically serve to prevent damage to the internal electrodes 121 and 122 caused by physical or chemical stress.

The upper cover portion 112 and the lower cover portion 113 may not include the internal electrodes 121 and 122, and may include a material the same as that of the dielectric layer 111. That is, the upper cover portion 112 and the lower cover portion 113 may include a ceramic material, for example, a barium titanate (BaTiO₃)-based ceramic material.

A thickness tc of each of the cover portions 112 and 113 is not particularly limited.

However, in order to more easily achieve miniaturization and to implement of high capacitance of the multilayer electronic component, the thickness of each of the cover portions 112 and 113 may be 100 μm or less, preferably 30 μm or less, and more preferably 20 μm or less in ultra-small products.

Here, the thickness tc of each of the cover portions 112 and 113 may refer to a size of each of the cover portions 112 and 113 in the first direction. In addition, the thickness tc of each of the cover portions 112 and 113 may refer to an average thickness tc of each of the cover portions 112 and 113, and may refer to an average size of each of the cover portions 112 and 113 in the first direction.

The average size of each of the cover portions 112 and 113 in the first direction may be measured by scanning, with an SEM, images of the cross-sections of the body 110 in the first and second directions at a magnification of 10,000. More specifically, the average size may be an average value of thicknesses of one cover portion, measured at thirty points equally spaced apart from each other in the second direction, in the scanned image.

The multilayer electronic component 100 may include side margin portions 114 and 115 disposed on both end surfaces of the body 110 in the third direction.

More specifically, the side margin portions 114 and 115 may include a first side margin portion 114 disposed on the fifth surface 5 of the body 110 and a second side margin portion 115 disposed on the sixth surface 6 of the body 110.

As illustrated, the side margin portions 114 and 115 may refer to a region between both end surfaces of the first and second internal electrodes 121 and 122 in the third direction and a boundary surface of the body 110, based on the cross-sections of the body 110 in the first and third direction.

The side margin portions 114 and 115 may form the internal electrodes 121 and 122 by applying a conductive paste onto a ceramic green sheet applied to the capacitance formation portion Ac, except a portion in which the side margin portions 114 and 115 are to be formed. In order to suppress a step caused by the internal electrodes 121 and 122, the internal electrodes 121 and 122 may be stacked and cut to be exposed through the fifth and sixth surfaces 5 and 6 of the body 110, and then a single dielectric layer 111 or two or more dielectric layers 111 may be stacked on both end surfaces of the capacitance formation portion Ac in the third direction to form the side margin portions 114 and 115.

The side margin portions 114 and 115 may basically serve to prevent damage to the internal electrodes 121 and 122 due to physical or chemical stress.

The first side margin portion 114 and the second side margin portion 115 may not include the internal electrodes 121 and 122, and may include a material the same as that of the dielectric layer 111. That is, the first side margin portion 114 and the second side margin portion 115 may include a ceramic material, for example, a barium titanate (BaTiO₃)-based ceramic material.

A width wm of each of the first and second side margin portions 114 and 115 is not particularly limited.

However, in order to more easily achieve miniaturization and to implement high capacitance of the multilayer electronic component 100, the width wm of each of the side margin portions 114 and 115 may be 100 μm or less, preferably 30 μm or less, and more preferably 20 μm or less in ultra-small products.

Here, the width wm of each of the side margin portions 114 and 115 may refer to a size of each of the side margin portions 114 and 115 in the third direction. In addition, the width wm of each of the side margin portions 114 and 115 may refer to an average width wm of each of the side margin portions 114 and 115, and may refer to an average size of each of the side margin portions 114 and 115 in the third direction.

The average size of each of the side margin portions 114 and 115 in the third direction may be measured by scanning, with an SEM, images of cross-sections of the body 110 in the first and third directions at a magnification of 10,000. More specifically, the average size may be an average value of sizes in the third direction, measured at thirty points equally spaced apart from each other in the first direction, in the scanned image.

In an example embodiment of the present disclosure, a structure in which a ceramic electronic component 100 has two external electrodes 131 and 132 is described, but the number, shape, or the like of the external electrodes 131 and 132 may vary depending on the shape or other purposes of the internal electrodes 121 and 122.

The external electrodes 131 and 132 may be disposed on the body 110 to be connected to the internal electrodes 121 and 122.

More specifically, the external electrodes 131 and 132 may include the first and second external electrodes 131 and 132 disposed on the third and fourth surfaces 3 and 4 of the body 110 and connected to the first and second internal electrodes 121 and 122, respectively. That is, the first external electrode 131 may be disposed on the third surface 3 of the body 110 to be connected to the first internal electrode 121, and the second external electrode 132 may be disposed on the fourth surface 4 of the body 110 to be connected to the second internal electrode 122.

The external electrodes 131 and 132 may be formed using any material as long as it has electrical conductivity, such as metal, and a specific material may be determined in consideration of electrical properties, structural stability, and the like. Furthermore, the external electrodes 131 and 132 may have a multilayer structure.

For example, the external electrodes 131 and 132 may include electrode layers 131a, 132a, 131b and 132b disposed on the body 110 and plating layers 131c and 132c disposed on the electrode layers 131a, 132a, 131b and 132b.

For more specific examples of the electrode layers 131a, 132a, 131b and 132b, the electrode layers 131a, 132a, 131b and 132b may be a sintered electrode including a conductive metal and glass or a resin-based electrode including a conductive metal and a resin.

In addition, the electrode layers 131a, 132a, 131b and 132b may have a form in which the sintered electrode and the resin-based electrode are sequentially formed on a body.

In addition, the electrode layers 131a, 132a, 131b and 132b may be formed by transferring a sheet including a conductive metal onto the body or transferring the sheet including the conductive metal onto the sintered electrode.

A material having excellent electrical conductivity may be used as a conductive metal included in the electrode layers 131a, 132a, 131b and 132b. For example, the conductive metal may be at least one selected from the group consisting of nickel (Ni), copper (Cu), palladium (Pd), silver (Ag), gold (Au), platinum (Pt), tin (Sn), tungsten (W), titanium (Ti), and alloys thereof, but the present disclosure is not particularly limited thereto.

In an example embodiment of the present disclosure, the electrode layers 131a, 132a, 131b and 132b may have a two-layer structure including the first electrode layers 131a and 132a and the second electrode layers 131b and 132b. Accordingly, the external electrodes 131 and 132 may include first electrode layers 131a and 132a including a conductive metal and glass, and second electrode layers 131b and 132b disposed on the first electrode layers 131a and 132a and including a conductive metal and resin.

The first electrode layers 131a and 132a including glass may serve to improve adhesion to the body 110, and the second electrode layers 131b and 132b including a resin may serve to improve bending strength.

The conductive metal used for the first electrode layers 131a and 132a is not particularly limited as long as it is electrically connectable to the internal electrodes 121 and 122 to form capacitance. For example, the conductive metal may include at least one selected from the group consisting of nickel (Ni), copper (Cu), palladium (Pd), silver (Ag), gold (Au), platinum (Pt), tin (Sn), tungsten (W), titanium (Ti), and alloys thereof. The first electrode layers 131a and 132a may be formed by applying a conductive paste prepared by adding a glass frit to conductive metal particle and then sintering the conductive paste.

The conductive metal included in the second electrode layers 131b and 132b may serve to allow electrical connection to the first electrode layers 131a and 132a.

The conductive metal included in the second electrode layers 131b and 132b is not particularly limited as long as it is electrically connectable to the electrode layers 131a and 132a, and the conductive metal may include at least one selected from the group consisting of nickel (Ni), copper (Cu), palladium (Pd), silver (Ag), gold (Au), platinum (Pt), tin (Sn), tungsten (W), titanium (Ti), and alloys thereof.

The conductive metal included in the second electrode layers 131b and 132b may include at least one of spherical particles and flake-type particles. That is, the conductive metal may be formed of only flake-type particles, or may be formed of only spherical particles, or may be a mixture of flake-type particles and spherical particles. Here, the spherical particles may include a shape that is not completely spherical, for example, a shape in which a length ratio (long axis/short axis) between the long axis and the short axis is 1.45 or less. The flake-type particles may refer to particles having flat and elongated shapes, and the present disclosure is not particularly limited thereto. However, for example, the length ratio (long axis/short axis) between the long axis and the short axis may be 1.95 or more. Lengths of the long axis and the short axis of the spherical particles and the flake-type particles may be measured from images obtained by scanning, with an SEM, cross-sections in the first and second directions of a central portion of the ceramic electronic component in the third direction.

The resin included in the second electrode layers 131b and 132b may serve to secure adhesion and absorb impact. The resin included in the second electrode layers 131b and 132b is not particularly limited as long as it has adhesion and impact absorption properties and is mixed with conductive metal particle to form a paste. The resin may include, for example, an epoxy-based resin.

In addition, the second electrode layers and 132b may include a plurality of metal particles, an intermetallic compound, and a resin. As the intermetallic compound is included therein, the second electrode layers 131b and 132b may further improve electrical connectivity with the first electrode layers 131a and 132a. The intermetallic compound may serve to improve electrical connectivity by connecting the plurality of metal particles to each other, and may surround the plurality of metal particles and connect the plurality of metal particles to each other.

In this case, the intermetallic compound may include a metal having a melting point lower than a curing temperature of the resin. That is, since the intermetallic compound includes the metal having the melting point lower than the curing temperature of the resin, the metal having the melting point lower than the curing temperature of the resin may be molten during drying and curing processes, and may surround the metal particles by forming the intermetallic compound with a portion of the metal particles. In this case, the intermetallic compound may preferably include metal having a low melting point of 300 °C or less.

For example, the intermetallic compound may include Sn having a melting point of 213 to 220 °C. During the drying and curing processes, Sn may be molten, and the molten Sn may allow metal particles having a high melting point, such as Ag, Ni, or Cu, to be wetted by a capillary phenomenon, and the molten Sn may react with a portion of Ag, Ni, or Cu metal particles to form an intermetallic compound such as Ag₃Sn, Ni₃Sn₄, Cu₆Sn_{5,} Cu₃Sn, or the like. Ag, Ni, or Cu not reacting therewith may remain in the form of metal particles.

Accordingly, the plurality of metal particles may include one or more of Ag, Ni, and Cu, and the intermetallic compound may include one or more of Ag₃Sn, Ni₃Sn₄, Cu₆Sn₅, and Cu₃Sn.

The plating layers 131c and 132c serve to improve mounting properties.

A type of the plating layers 131c and 132c is not particularly limited, and may be a single layer of plating layers 131c and 132c including at least one of nickel (Ni), tin (Sn), palladium (Pd), and alloys thereof, and may be formed of a plurality of layers.

For more specific example, the plating layers 131c and 132c may be Ni plating layers or Sn plating layers, and may have a form in which a Ni plating layer and a Sn plating layer are sequentially formed on the electrode layers 131a, 132a, 131b and 132b, and a form in which a Sn plating layer, a Ni plating layer and a Sn plating layer are sequentially formed on the electrode layers 131a, 132a, 131b and 132b. In addition, the plating layers 131c and 132c may include a plurality of Ni plating layers and/or a plurality of Sn plating layers.

While example embodiments have been shown and described above, it will be apparent to those skilled in the art that modifications and variations could be made without departing from the scope of the present disclosure as defined by the appended claims.

In addition, the term "an embodiment" does not refer to the same embodiment, and describe different unique features of various embodiments. However, the above-suggested embodiments may also be implemented to be combined with a feature of another embodiment. For example, even when a content described with respect to an embodiment is not described in another embodiment, it may be understood as a description related to the other embodiment unless described to the contrary or contradictory in the other embodiment.

The terms used herein are merely used to describe a specific example embodiment, and are not intended to limit the present disclosure. Singular forms may include plural forms as well unless the context clearly indicates otherwise.

What is claimed is:

1. A method of preparing a dispersant, the method comprising:
preparing a first solution by dissolving polyvinyl alcohol in an organic solvent;
preparing a second solution by adding an acidic solution to the first solution;
preparing a third solution by adding an aldehyde to the second solution; and
obtaining a polyvinyl acetal-based resin by precipitating the third solution in a water-soluble solvent,
wherein the polyvinyl acetal-based resin has a degree of polymerization in a range from 100 to 200, an amount of hydroxyl groups in a range from 4 mol% to 40 mol%, an amount of an acetal groups in a range from 40 mol% to 95 mol%, and an amount of acetyl groups o in a range from 1 mol% to 20 mol%, and wherein the polyvinyl acetal-based resin is prepared by acetalizing a polyvinyl alcohol-based resin through a non-aqueous homogeneous reaction in a polar aprotic solvent.

2. The method of claim 1, wherein the polyvinyl alcohol has a polymerization degree of 100 or more and 200 or less.

3. The method of claim 1, wherein the organic solvent includes a polar aprotic solvent.

4. The method of claim 3, wherein the polar aprotic solvent includes at least one of N-methyl-2-pyrrolidone, acetone, ethyl acetate, acetonitrile, tetrahydrofuran, dimethyl sulfoxide, N-dimethylformamide, N,N-dimethylacetamide, pyridine, and hexamethylphosphoramide.

5. The method of claim 1, wherein the polyvinyl acetal-based resin has a molecular weight in a range from 5000 g/mol to 16000 g/mol.

6. The method of claim 1, wherein the polyvinyl acetal-based resin is a polyvinyl butyral resin.

7. The method of claim 1, wherein dissolving the polyvinyl alcohol in the organic solvent is performed at a temperature in a range from 100 ^{o}C to 150 ^{o}C.

8. The method of claim 1, wherein the aldehyde is selected from the group consisting of acetaldehyde, propionaldehyde, benzaldehyde, and a combination thereof.

9. The method of claim 1, wherein obtaining the polyvinyl acetal-based resin by precipitating the third solution in a water-soluble solvent comprises adding an alkali to the third solution after a predetermined period of time.

10. The method of claim 9, wherein the alkali is added in an amount in a range from 0.1 g to 5.0 g for 1 l of the water-soluble solvent.

11. The method of claim 9, wherein the predetermined period of time is in a range from 2 hours to 72 hours.
